(19) United States
(12) Patent Application Publication
(10) Pub. No.: US 2016/0173917 A1
(43) Pub. Date: Jun. 16, 2016

(54) SYSTEM AND METHOD FOR INTELLIGENT PACKET REPLACEMENT FOR MOTION PICTURE EXPERT GROUP TRANSPORT STREAM SPLICING

(71) Applicant: International Datacasting Corporation, Kanata (CA)

(72) Inventors: Kirill Bocharnikov, Kanata (CA); Michael Heitner, Ontario (CA); Babak Shaikhvand, San Diego, CA (US)

(21) Appl. No.: 14/965,979

(22) Filed: Dec. 11, 2015

Related U.S. Application Data
(60) Provisional application No. 62/091,091, filed on Dec. 12, 2014.

(51) Int. Cl. H04N 21/234; H04N 21/2365; H04N 21/2187; H04N 21/236; H04N 21/2381; H04H 20/42

(52) U.S. Cl. CPC H04N 21/23424; H04N 21/2381; H04H 20/423; H04N 21/2187; H04N 21/23614; H04N 21/2365

(57) ABSTRACT

An apparatus to splice MPEG transport streams in a communications network comprises an input to receive a first transport stream and a storage unit storing a second transport stream. A packet replacement module is coupled to the input and the storage unit. The packet replacement module receives the first transport stream from the input and the second transport stream from the storage unit and categorizes the packets into a first packet type and a second packet type and storing them into a buffer. The packet replacement module replaces packets of the first packet type from the first transport stream with packets of the first packet type from the second transport stream and replaces packets of the second packet type from the first transport stream with packets of the second packet type from the second transport stream, producing a spliced transport stream.

### CROSS-REFERENCE TO RELATED APPLICATION(S)

This application claims priority to U.S. Provisional Application No. 62/091,091 filed Dec. 12, 2014, which is hereby incorporated by reference herein in its entirety.

### FIELD OF THE INVENTION

The present disclosure generally relates to digital media broadcasting and commercial insertion. More specifically it relates to the transmission and splicing of Motion Picture Expert Group transport streams.

### BACKGROUND OF THE INVENTION

MPEG transport streams are use to transmit and broadcast a wide variety of digital video and audio content. In MPEG single-frequency network (SFN) applications additional information is included in the transport stream to implement metrics which measure distances and timing between specific packets and parts of the stream to catch errors and ensure bit-identicality between units in SFN networks.

When new content is spliced into an MPEG transport stream existing approaches are to simply insert the new packets into the live stream. However, this has several drawbacks. Inserting the new content in its entirety into the live content changes the structure of the live stream and these metrics become invalid. Furthermore, there are metrics for SFN networks to measure structural identicality between the streams broadcast by the various transmitters. Changing the structure of the live stream will make these metrics invalid. Therefore, there is a need for a more intelligent solution to overcome these problems.

### SUMMARY OF THE INVENTION

In an embodiment of the invention comprises an apparatus to splice MPEG transport streams in a communications network. The apparatus includes an input to receive a first transport stream which comprises packets and a storage unit storing therein a second transport stream which comprises packets. A packet replacement module is coupled to the input and the storage unit. The packet replacement module receives the first transport stream from the input and the second transport stream from the storage unit and categorizes the packets from the first transport stream and the second transport stream into a first packet type and a second packet type and stores them into a buffer. The packet replacement module replaces packets of the first packet type from the first transport stream with packets of the first packet type from the second transport stream, and replaces packets of the second packet type from the first transport stream with packets of the second packet type from the second transport stream. The first transport stream and the second transport stream are merged into a spliced transport stream.

Some embodiments of the invention include a second input that receives the second transport stream and stores it in the storage unit.

In other embodiments of the invention the packet replacement module monitors the first transport stream to determine the SFN metrics of the first transport stream. In some cases, the spliced transport stream preserves the SFN metrics of the first transport stream.

Another embodiment of the invention includes a method of splicing two MPEG transport streams in a communications network. A first transport stream and a second transport stream are received where the first transport stream and the second transport stream comprise packets of a first type and a second type. The packets received from the first transport stream and the second transport stream are categorized into the first type and the second type and stored into a buffer. A first packet of the first type received from the first transport stream is selected and replaced with a second packet of the first type received from the second transport stream. A third packet of the second type received from the first transport stream is selected and replaced with a fourth packet of the second type received from the second transport stream.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

The foregoing and other advantages of the disclosure will become apparent upon reading the following detailed description and upon reference to the drawings.

FIG. 1 shows a typical arrangement for Single Frequency Network (SFN) transmission.

FIG. 2A shows a system diagram for splicer.

FIG. 2B shows an example embodiment of the intelligent packet replacement module.

FIG. 2C shows an example flowchart of an embodiment of intelligent packet replacement.

FIG. 2D shows an example flowchart of selection of packets from the new content to replace packets in the live stream.

FIG. 3 shows an example intelligent packet replacement technique.

FIG. 4A is a block diagram of one example of step 2D-01 in FIG. 2D.

FIG. 4B is a block diagram of one example of step 2D-03 in FIG. 2D.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

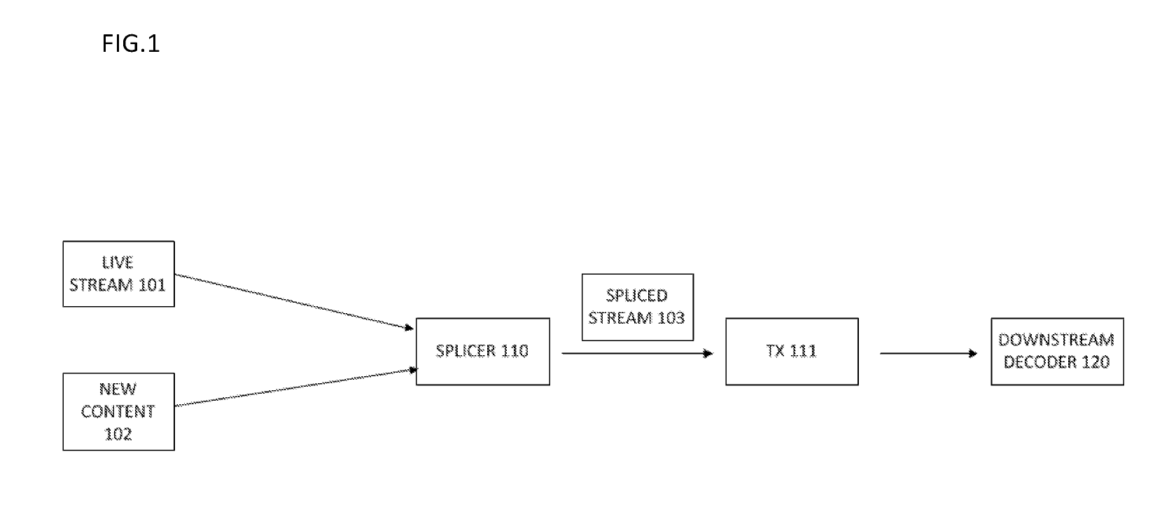

FIG. 1 shows an example arrangement for a Single Frequency Network (SFN). Content from a Motion Picture Expert Group (MPEG) live input stream 101 is fed to a transport stream splicer 110. At the splicer, live stream 101 is spliced with new content 102, and the output spliced stream 103 is sent to a transmitter 111. This output spliced stream 103 is transmitted; and received and decoded by a downstream receiver/decoder 120. The live stream 101 and new content 102 contain multiple types of packets, such as, for example, video and audio packets.

The new content 102 is, for example:

data stored locally on a hard drive within the splicer, or in remote storage, or

a stream input into the splicer and different from the live stream 101.

While these examples have been presented, it is known to one of skill in the art that new content is not limited to only these examples of sources.

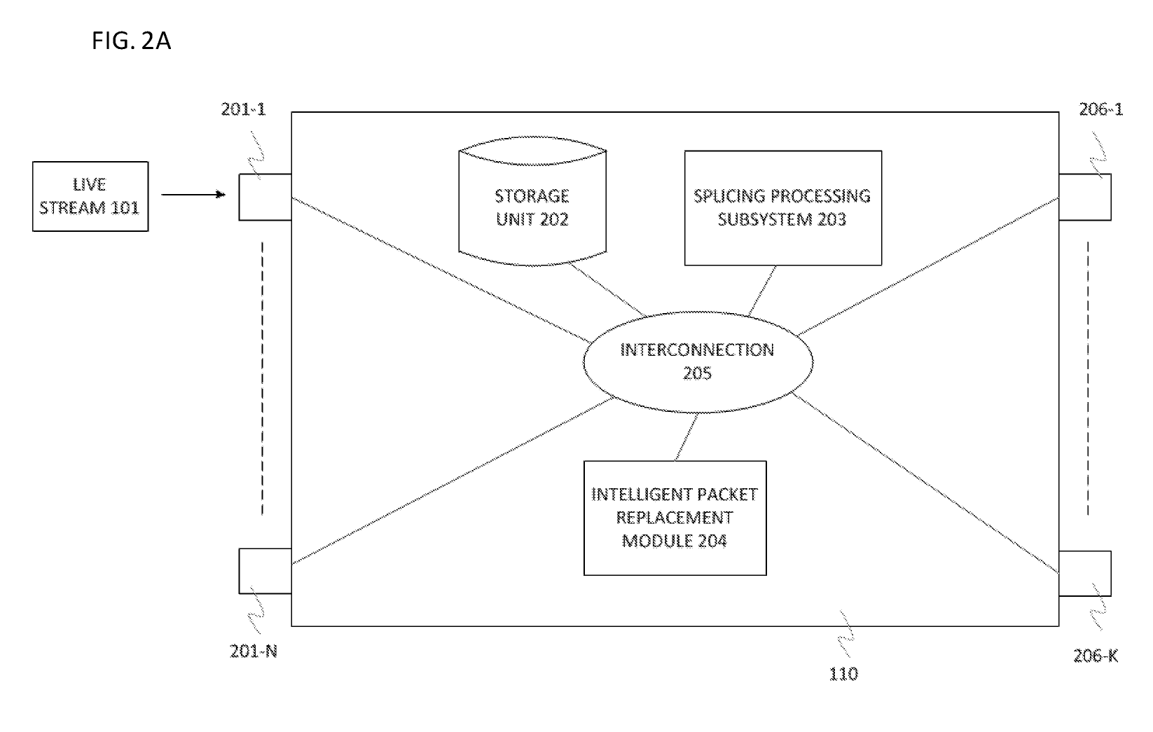

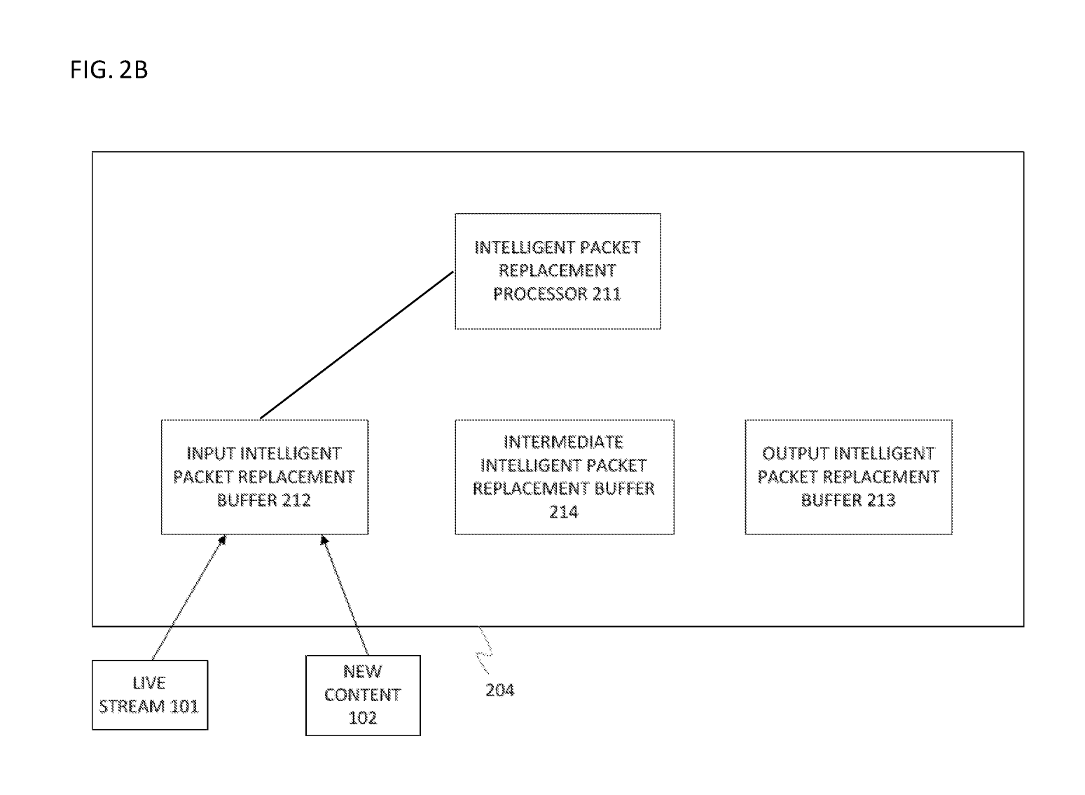

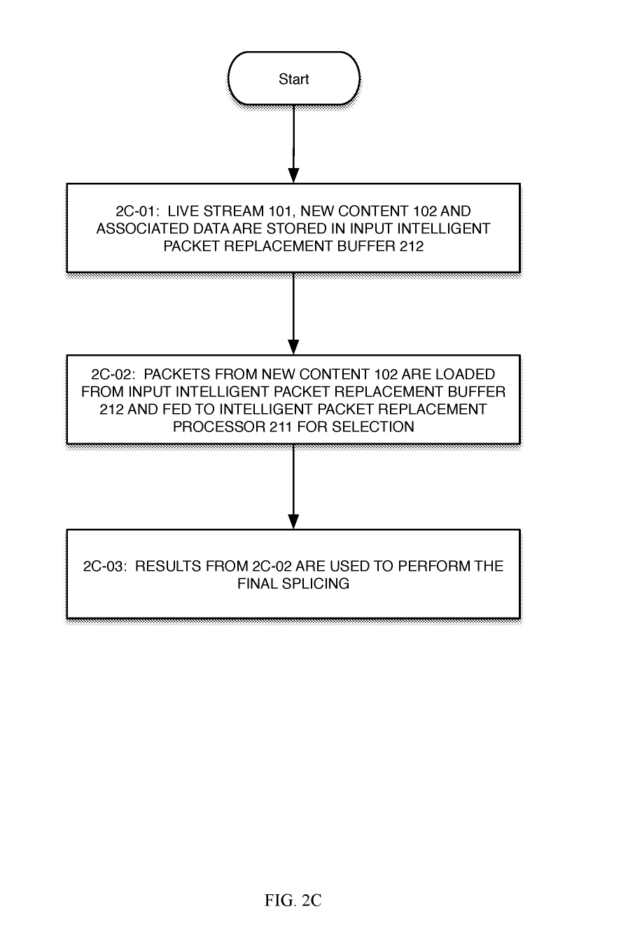

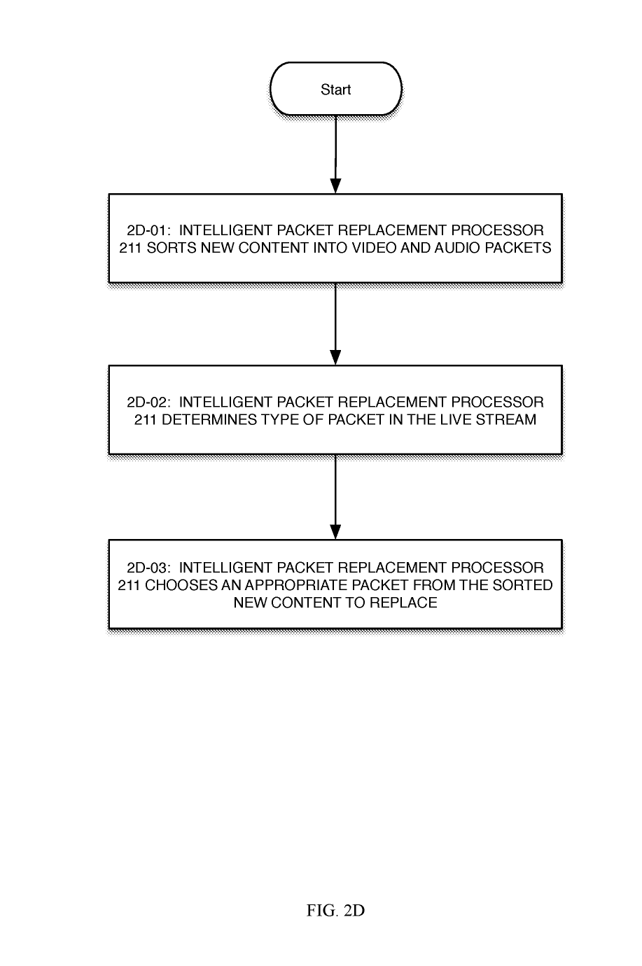

FIG. 2A illustrates an embodiment of the invention where splicer 110 is enhanced with an intelligent packet replacement module 204. The intelligent packet replacement module 204 may be implemented in hardware, software, or a combination of hardware and software. In another embodiment, intelligent packet replacement module 204 is implemented using custom hardware or software one or more servers. The intelligent packet replacement module 204 is coupled to the other components using interconnection 205.

Intelligent packet replacement module 204 is shown in further detail in FIG. 2B. The intelligent packet replacement module 204 comprises an intelligent packet replacement processor 211, an input intelligent packet replacement buffer 212, intermediate packet replacement buffer 214, and an output intelligent packet replacement buffer 213.

An example flowchart of an embodiment of intelligent packet replacement is shown in FIG. 2C. In step 2C-01, the input live stream 101; new content 102; and data associated with the input stream and new content are initially stored in the input intelligent packet replacement buffer 212. The input live stream is analyzed to determine the SFN metrics present in the stream and that must be preserved in the spliced transmitted stream at the transmitter output 111. The splicer 111 may use this information when splicing the new content 102 into the live stream 101 in order to either preserve the SFN metrics or be able to transmit valid SFN metrics.

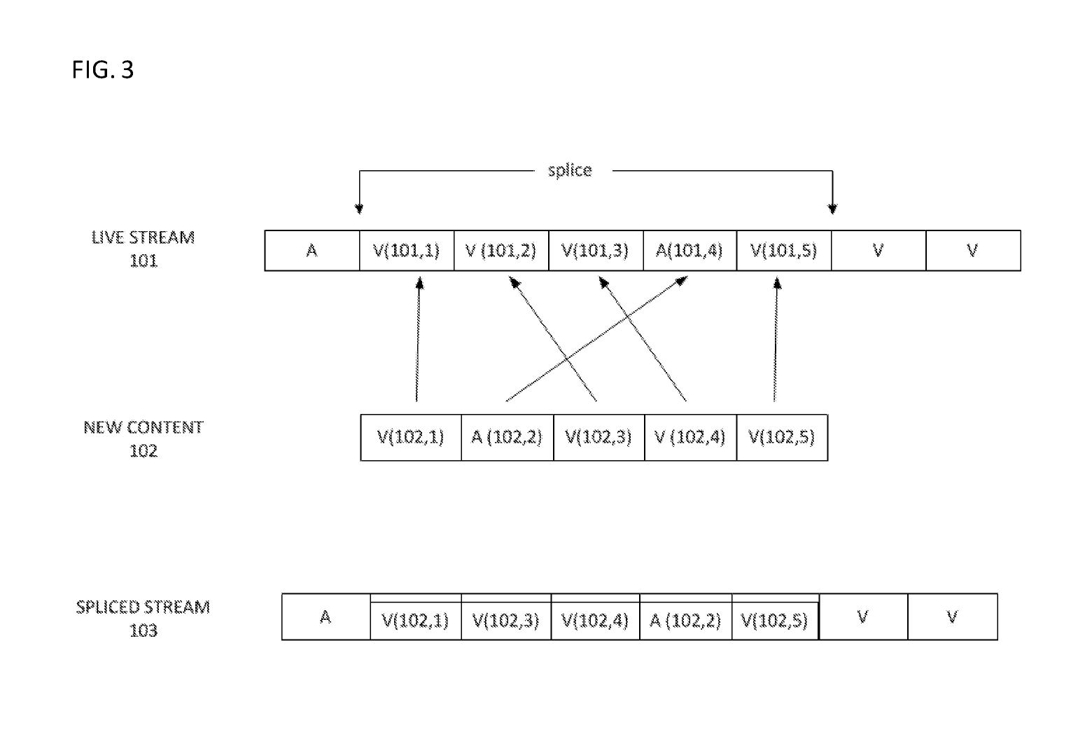

In step 2C-02, intelligent packet replacement processor 211 selects packets from new content 102 to replace packets in live stream 101. In this step, packets from the new content 102 are loaded from input intelligent packet replacement buffer 212 and sent to intelligent packet replacement processor 211 for selection. As shown in FIG. 3, the portion of the live stream 101 to be spliced has 4 video packets, labeled V(y,n), and 1 audio packet, labeled A(y,n), where y is indicates the stream and n is the packet number. The packets from the new content 102 will need to be selected and buffered before replacement so as to maintain the original structure. By doing it this way, the structure, comprising the ratio, number, and placement of audio and video packets, of the result stream 103 is the same as that of the live stream 101.

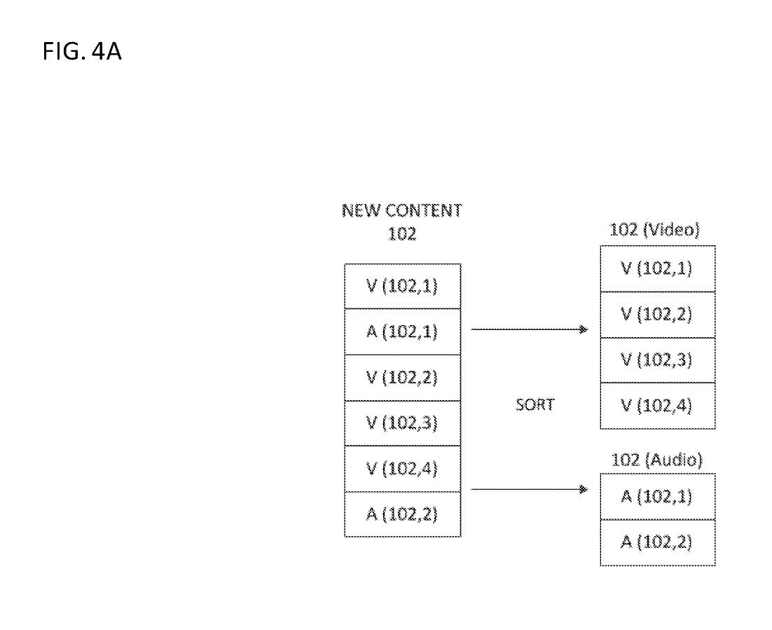

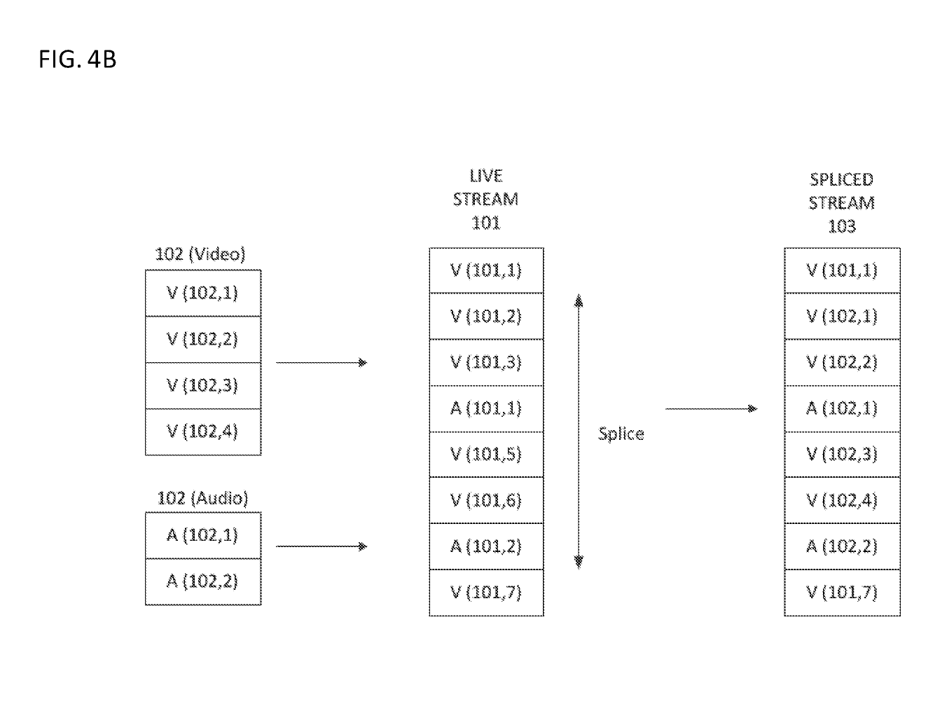

In one embodiment, selection step 2C-02 is carried out as shown in the example flowchart of FIG. 2D. In step 2D-01, the intelligent packet replacement processor 221 sorts the new content 102 into video and audio packets, denoted by 102(Video) and 102(Audio) as shown in FIG. 4A, and stores the sorted content 102(Video) and 102(Audio) in the intermediate packet replacement buffer 214.

In step 2D-02, the intelligent packet replacement processor 211 determines the type of packet in the live stream using methods known in the art.

In step 2D-03 the intelligent packet replacement processor 211 chooses an appropriate packet from the sorted new content stored in the intermediate packet replacement buffer 214 to replace this packet.

For example, as shown in FIG. 4B, if the live stream 101 packet is determined to be video, then a video packet is chosen from the video packets in the sorted new content. If the live stream packet is determined to be audio, then an audio packet is chosen from the audio packets in the sorted new content. For example, V(101,2) is determined by the intelligent packet replacement processor 211 to be a video packet. Then, intelligent packet replacement processor 211 chooses the V(102,1) packet to replace V(101,2). A similar process is carried out for each of the packets in live stream 101, as shown in FIG. 4B.

In step 2C-03, the results from step 2C-02 are sent to, for example, the splicing processing subsystem 203 of FIG. 2A to perform the final splicing. In one embodiment, the live stream and selected packets from the new content are stored in the output intelligent packet replacement buffer 214 before being loaded and sent to the splicing processing subsystem 203.

In another embodiment, the intelligent packet replacement module 204 is part of splicing processing subsystem 203. Then using the results, the selected packets from the new content are unloaded from intermediate intelligent packet replacement buffer 213. The live stream is unloaded from input intelligent packet replacement buffer 212 and the final splicing is performed.

It would be known to one of skill in the art that there are many possible ways to implement the selection process of FIG. 2D. For example, the sorting could be performed using pointers to the addresses of the video and audio packets in the input intelligent packet replacement buffer 212.

It would also be known to one of skill in the art that while the above concerns video and audio packets, it is possible to generalize this approach for types of packets other than video and audio.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. An apparatus to splice MPEG transport streams in a communications network, the apparatus comprising:
an input to receive a first transport stream comprising packets;
a storage unit storing therein a second transport stream comprising packets;
a packet replacement module coupled to the input and the storage unit, the packet replacement module receiving the first transport stream from the input and the second transport stream from the storage unit, the packet replacement module categorizing packets from the first transport stream and the second transport stream into a first packet type and a second packet type and storing them into a buffer;
the packet replacement module replacing packets of the first packet type from the first transport stream with packets of the first packet type from the second transport stream, and replacing packets of the second packet type from the first transport stream with packets of the second packet type from the second transport stream wherein the first transport stream and the second transport stream are merged into a spliced transport stream.

2. The apparatus of claim 1 further comprising a second input, the second input receiving the second transport stream and storing it in the storage unit.

3. The apparatus of claim 1 wherein the packet replacement module monitors the first transport stream to determine the SFN metrics of the first transport stream.

4. The apparatus of claim 3 wherein the spliced transport stream preserves the SFN metrics of the first transport stream.

5. A method of splicing two MPEG transport streams in a communications network, the method comprising:
receiving a first transport stream and a second transport stream, the first transport stream and the second transport stream comprising packets of a first type and a second type;
categorizing packets received from the first transport stream and the second transport stream into the first type and the second type and storing them into a buffer;
selecting a first packet of the first type received from the first transport stream and replacing it with a second packet of the first type received from the second transport stream;
selecting a third packet of the second type received from the first transport stream and replacing it with a fourth packet of the second type received from the second transport stream.

6. The method of claim 5 wherein the first transport stream is received through a first input, the second transport stream is received through a second input, and the second transport stream is stored in a storage unit before categorizing the packets of the second transport stream.

7. The method of claim 5 further comprising monitoring the first transport stream to determine the SFN metrics of the first transport stream.

8. The method of claim 7 wherein after replacing packets received from the first transport stream with packets received from the second transport stream the SFN metrics of the first transport stream are preserved.
